(19) United States
(12) Patent Application Publication
(10) Pub. No.: US 2018/0314774 A1
(43) Pub. Date: Nov. 1, 2018

(54) System Performance Measurement of Stochastic Workloads

(71) Applicant: Dell Products L.P., Round Rock, TX (US)

(72) Inventors: Farzad Khosrowpour, Pflugerville, TX (US); Nikhil Vichare, Austin, TX (US)

(73) Assignee: Dell Products L.P., Round Rock, TX (US)

(21) Appl. No.: 15/499,050

(22) Filed: Apr. 27, 2017

(51) Int. Cl. G06F 17/50; G06F 11/34; G06F 11/30

(52) U.S. Cl. CPC G06F 17/5009; G06F 11/302; G06F 11/3433

(57) ABSTRACT

A system, method, and computer-readable medium are disclosed for identifying a simulated application load that represents a target application workload to use when executing a performance optimization operation based upon a particular workload; testing the information handling system being optimized by executing the simulated application load that represents the target application workload on the information handling system; profiling a workload of the information handling system based upon executing the simulated application load that represents the target application workload; applying performance optimization changes to the information handling system based upon the data analysis, the performance optimization changes being applied automatically and seamlessly; analyzing performance of the information handling system after the performance analysis changes are applied; and, presenting information regarding performance improvement as to allow a user to appreciate an effect of the performance optimization changes to the information handling system.

### BACKGROUND OF THE INVENTION

### Field of the Invention

The present invention relates to information handling systems. More specifically, embodiments of the invention relate to system performance measurement of stochastic workloads.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With certain information handling systems, different applications can leverage system resources differently. Some applications may be multi-threaded and some applications may be single threaded. Some applications can benefit from a faster CPU speed and others from faster IO performance (e.g., due to transactional access to storage). It is known to adjust system resources for a particular application based upon static benchmark based characteristics for that application.

### SUMMARY OF THE INVENTION

A system, method, and computer-readable medium are disclosed for identifying a simulated application load that represents a target application workload to use when executing a performance optimization operation based upon a particular workload; testing the information handling system being optimized by executing the simulated application load that represents the target application workload on the information handling system; profiling a workload of the information handling system based upon executing the simulated application load that represents the target application workload; applying performance optimization changes to the information handling system based upon the data analysis, the performance optimization changes being applied automatically and seamlessly; analyzing performance of the information handling system after the performance analysis changes are applied; and, presenting information regarding performance improvement as to allow a user to appreciate an effect of the performance optimization changes to the information handling system.

In various embodiments, a performance optimization operation includes performing an application specific system configuration operation. In various embodiments, the application specific system configuration operation measures performance statistics against a simulated application load that represents a target application workload. A plurality of performance measurements are generated when comparing performance statistics against pre-characterized simulated workloads. The performance measurements include one or more of response time performance measurements, time to completion performance measurements and latency performance measurements. In various embodiments, the application specific system configuration operation correlates longer benchmark tests to smaller simulated loads to generate an application specific system configuration performance score. In various embodiments, the application specific system configuration operation use shorter simulated loads on customers systems to simulate benchmarks. In various embodiments, the application specific system configuration operation provides a performance gain percentage measure after one or more recommended configuration settings are changed.

An application may run in different modes, resulting in different workloads. Real time performance measurements are not an exact measurement of the overall performance of an application. Statistical measurements are more commonly used for performance optimization allowing data analysis across different performance characteristics for the application such as compute, TO, and memory over a period of time. Since such models do not provide a method to measure the performance,

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a performance optimization environment.

FIG. 3 shows a flow chart of operations performed by the performance optimization system.

FIG. 4 shown a graphical representation of normalized sample points of an information handling system.

FIG. 5 shows a sample system performance index.

### DETAILED DESCRIPTION

Various aspects of the present disclosure include an appreciation that proper changes in system configuration (which can include resource allocation) can result in an optimal performance environment for an application executing on an information handling system. Various aspects of the present disclosure include an appreciation that some of these system configuration changes may be at a hardware level and other system configuration changes can relate to optimization of processes and priorities of the operating system (collectively called a system). Yet other system configuration changes may be configuration optimization for specific applications.

Various aspects of the disclosure include an appreciation that it would be desirable to provide Key Performance Indicators (KPIs) as well as a way to define the performance improvement or degradation of the system at runtime. Various aspects of the disclosure include an appreciation that it would be desirable to provide indicators of how much improvement is made to the system when optimization is applied. Various aspects of the disclosure include an appreciation that it is desirable to describe the overall performance of the system while accounting for random variations in workloads (such as concurrency of applications, whether anti-virus software is executing, whether IT based software is present, etc.). Accordingly, it would be desirable to provide a method by which performance can be measured and compared with the changes that occur in a system.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

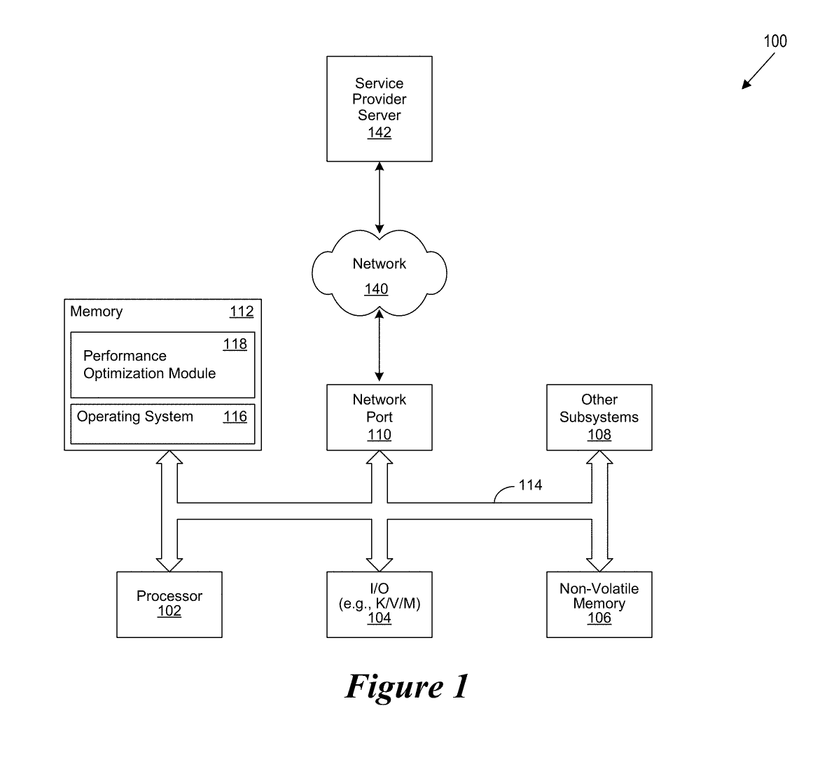

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a performance optimization module 118.

The performance optimization module 118 performs a performance optimization operation. The performance optimization operation improves the efficiency of the information handling system 100 by optimizing the performance of the information handling system when executing stochastic workloads. As will be appreciated, once the information handling system 100 is configured to perform the performance optimization operation, the information handling system 100 becomes a specialized computing device specifically configured to perform the performance optimization operation and is not a general purpose computing device. Moreover, the implementation of the performance optimization operation on the information handling system 100 improves the functionality of the information handling system and provides a useful and concrete result of improving the performance of the information handling system when the information handling system 100 experiences one or a combination of composite changes that may occur in a system workload of the information handling system 100.

In various embodiments, the performance optimization operation includes performing application specific system configuration operation. In various embodiments, the application specific system configuration operation measures performance statistics against a simulated application load that represents a target application workload. A plurality of performance measurements are generated when comparing performance statistics against pre-characterized simulated workloads. The performance measurements include one or more of response time performance measurements, time to completion performance measurements and latency performance measurements. In various embodiments, the application specific system configuration operation correlates longer benchmark tests to smaller simulated loads to generate an application specific system configuration performance score. In various embodiments, the application specific system configuration operation use shorter simulated loads on customers systems to simulate benchmarks. In various embodiments, the simulated benchmarks might be based upon either industry standard or Independent Software Vendor (ISV) owned benchmark tools to measure the performance of the hardware for running a specific workload. In case of ISV owned benchmarks, these tools runs workloads for the specific application developed by the ISV.

In various embodiments, the application specific system configuration operation provides a performance gain percentage measure after one or more recommended configuration settings are changed.

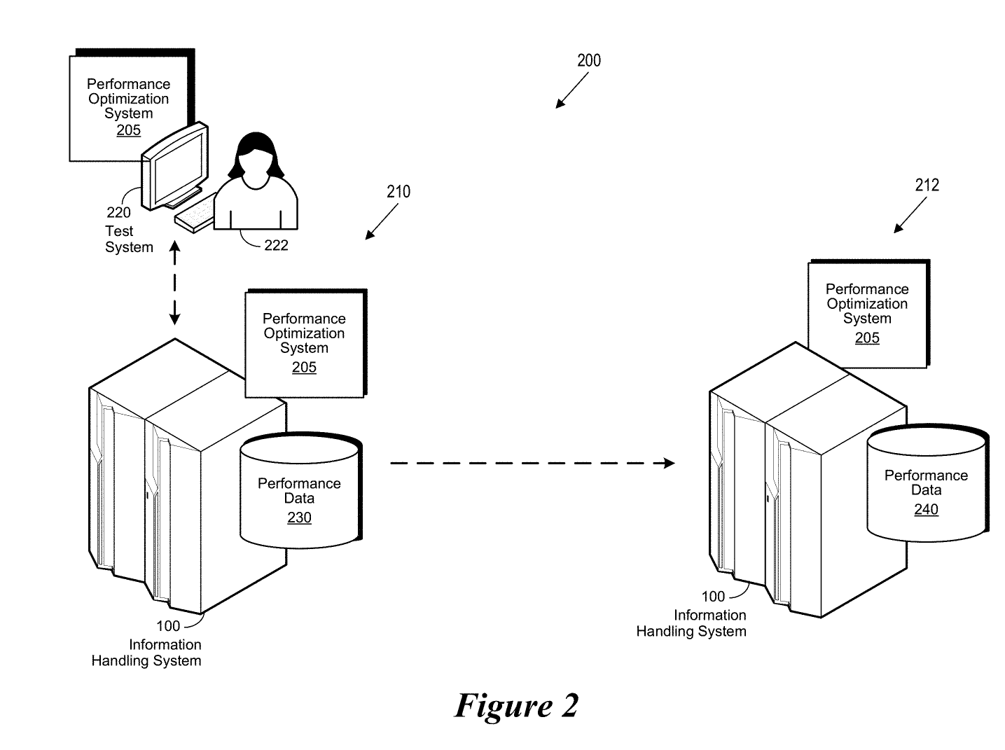

FIG. 2 shows a block diagram of a performance optimization environment 200. In various embodiments, the performance optimization environment 200 includes one or more performance optimization systems 205. Each performance optimization system 205 may perform some or all of a performance optimization operation.

The performance optimization environment 200 includes a developer portion 210 (which may also be a manufacturer portion) and a user portion 212. In various embodiments, the developer portion 210 includes a test system 220 (which may also be an information handling system 100) which interacts with the information handling system 100 for which the performance is being optimized. In various embodiments the developer portion 210 includes a repository of performance data 230. In certain embodiments, the information handling system for which the performance is being optimized includes application specific system configuration options. The user portion 212 includes an information handling system 100 which corresponds to some or all of the application specific system configuration options of the information handling system 100 from the developer portion 210. In various embodiments the user portion 212 includes a repository of performance data 240.

The performance optimization operation analyzes one or more composite changes which can affect system performance. For example, the composite change may include random stochastic variation in the amount of work performed over a period of time such as number of job submissions to the information handling system. The composite change may include the amount of work that is monotonically increasing or decreasing as a function of time such as increased number of records processed by an application over time. The composite change may include the amount of work performed which appears as an upward or downward nature such as periodic task scheduling. The composite change may include abrupt discontinuities in the workload such as operating system operations (e.g. context switching) or external factors such as user operations. In certain embodiments, the performance optimization operation addresses such complex workload changes through statistical models and iterative methods of sampling and adjustment.

In certain embodiments, the performance optimization operation enables comparison of performance against a baseline over a period of time. In certain embodiments, the performance optimization operation performs statistical analysis based on simulated application loads that represents a target application workload (i.e., dummy loads that suit a particular workload). In certain embodiments, the performance optimization operation reduces the time to a tractable amount by having a simulated application load that represents a target application workload simulate only a small subset of the benchmarks characterization. In certain embodiments, the performance optimization iteratively performs monitoring operations and comparison operations to make corrections in case of false trigger. False triggers may occur due to an unexpected increase in system utilization (e.g., from processor utilization, disk I/O utilization, etc.) that are not due to the workload being measured. This increased activity can generate spikes in the data which can then potentially lead to incorrect conclusions. For example, the system is being monitored for optimizing an AutoCAD related workload, and if the system starts installing large software packages in the background due to an unforeseen IT push, this activity could generate spikes in the utilization data and hence a false trigger about the need for more compute resources. So in iterative sequences the logic allows the best overall analysis for a mixed and changing workload.

In certain embodiments, the statistical analysis is seeded to enable faster decision making. In certain embodiments, the seeding provides characterization of the system during baselining and initialization. More specifically, the performance optimization operation executes a simulated application load that represents a target application workload which are characterized in the lab and their expected behavior is known (e.g. transactional workload, streaming, highly multi-threaded). In certain embodiments, the characteristics of the simulated application load that represents a target application workload change based on the hardware configuration of the information handling system. Accordingly, in certain embodiments, the performance optimization operation performs a hardware binding operation to better define the scope of the simulated application load that represents a target application workload. More specifically, the hardware binding operation associates a particular system configuration with the simulated application load. The simulated application load may then be executed on a plurality of different system configurations to provide baselines for the simulated application load across a plurality of different system configurations.

When performing the performance optimization operation there are a significant number (e.g., greater than 1000) of possible probes (i.e., possible test combinations) to analyze. Some of these parameters are dependent and some are independent. Lab tests have shown that cluster of workload is an overall system description of all jobs abstracting individual components. Characteristics of the device as baseline (for example performance of a drive as a maximum storage capability of that machine) are insufficient.

It has been discovered that a limited number of properties (e.g., two to four properties) need be analyzed when performing the performance optimization operation. The options are limited as part of the decision making logic and not linear interpretation of every combination. When creating workload characterization programs, a set of “representative samples” can show the normal processing load on the system and the results is stored for comparison. Then, the system can execute these representative samples in periodic worksteps in less than a specified amount of time as compared to a full benchmark.

In certain embodiments, the performance optimization operation analyzes three criteria against a baseline to determine the overall system performance. In certain embodiments the three criteria include one or more of a throughput criteria (i.e., a time to complete a job from start to finish), a response time (i.e., latency) criteria, and a resource utilization criteria. In various embodiments, several resource monitors may be probed in time-series to characterize the recourse utilization. These resources can include one or more of processor utilization, number of threads executing, utilization by a thread, processor, queue length, processor frequency (which may include turbo residency), memory utilization, paging activity, disk read and/or writes, graphics processor utilization, graphics processor memory consumption.

In certain embodiments, the total performance is assumed to be a normalized score (referred to as the performance score (PerfScore)) based on the simulated application load that represents a target application workload and as a function of application response time (ART), application throughput (AT), and system resource utilization (SRU) for a specific hardware configuration (HWC).

Thus, Perf Score=F (ART, AT, SRU, HWC).

A weighted distribution average of these data points determines the overall Perf Score for a specific hardware configuration is set forth as:

$$Perf Score ( t ) = {\sum }_{1}^{N} \frac{{a}_{i} * {ART ( t )}_{i} + {b}_{i} * {AT ( t )}_{i} + {c}_{i} * {SRU ( t )}_{i}}{N}$$

The weighted values of a, b, and c are constants that are determined based on classes of workloads. For example, is a workload is more sensitive to response time “a” will be a bigger value, whereas a workload that is more sensitive to throughput will result in a larger “b.” Such values can be empirically determined and become a look up table in the overall logic.

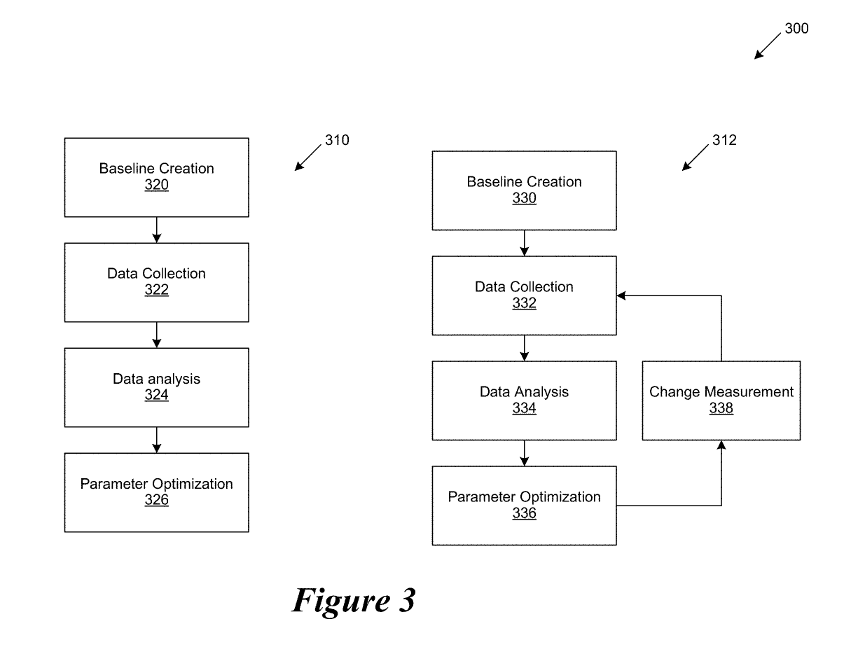

Referring to FIG. 3, a flow chart of operations performed by the performance optimization system 205 is shown. More specifically, the performance optimization system 205 performs developer portion performance optimization operations 310 and user portion performance optimization operation 312.

The developer portion performance optimization operations 312 include a baseline creation step 320, a data collection step 322, a data analysis step 324 and a parameter optimization step 326, which are each performed with the information handling system 100 that is associated with the developer portion 210. The baseline creation step 320 determines benchmarks for each of a plurality of criteria to provide baselines to determine the overall system performance. In certain embodiments, the plurality of criteria include application response time, application throughput and system resource utilization for a plurality of hardware configuration. The data collection step 322 tests the information handling system being optimized as well as the operating system executing on the information handling system being optimized. The data analysis step 324 analyzes the data collected during the data collection step and defines settings to be optimized and defines configuration information based upon the data analysis. The parameter optimization step 324 deploys a user interface for use by a user during the user portion to enable the user to select a performance optimization profile.

The user portion performance optimization operations 312 include a baseline creation step 330, a data collection step 332, a data analysis step 334, a parameter optimization step 336 and a change measurement step 338, which are each performed with the information handling system 100 that is associated with the user portion 212. The baseline creation step 320 identifies a simulated application load that represents a target application workload to use when executing the performance optimization operation based upon a particular workload. The baseline creation step 320 can also determine benchmarks for each of a plurality of criteria to provide baselines to determine the overall system performance. In certain embodiments, the plurality of criteria include application response time, application throughput and system resource utilization for a plurality of hardware configuration. The data collection step 322 unitizes run time counters and instrumentation to collect performance data. The data collection step 322 tests the information handling system being optimized as well as the operating system executing on the information handling system being optimized. The data analysis step 324 profiles the workload based upon executing the simulated application load that represents a target application workload. The data analysis step 324 further analyzes the data collected during the data collection step and defines settings to be optimized and defines configuration information based upon the data analysis. The parameter optimization step 324 automatically and seamlessly applies performance optimization changes based upon the data analysis. The change measurement step 338 analyzes the performance after the performance analysis changes are applied. In certain embodiments, the change measurement step 338 presents the performance improvement as a percentage change improvement to allow a user to appreciate the effect of the performance optimization changes.

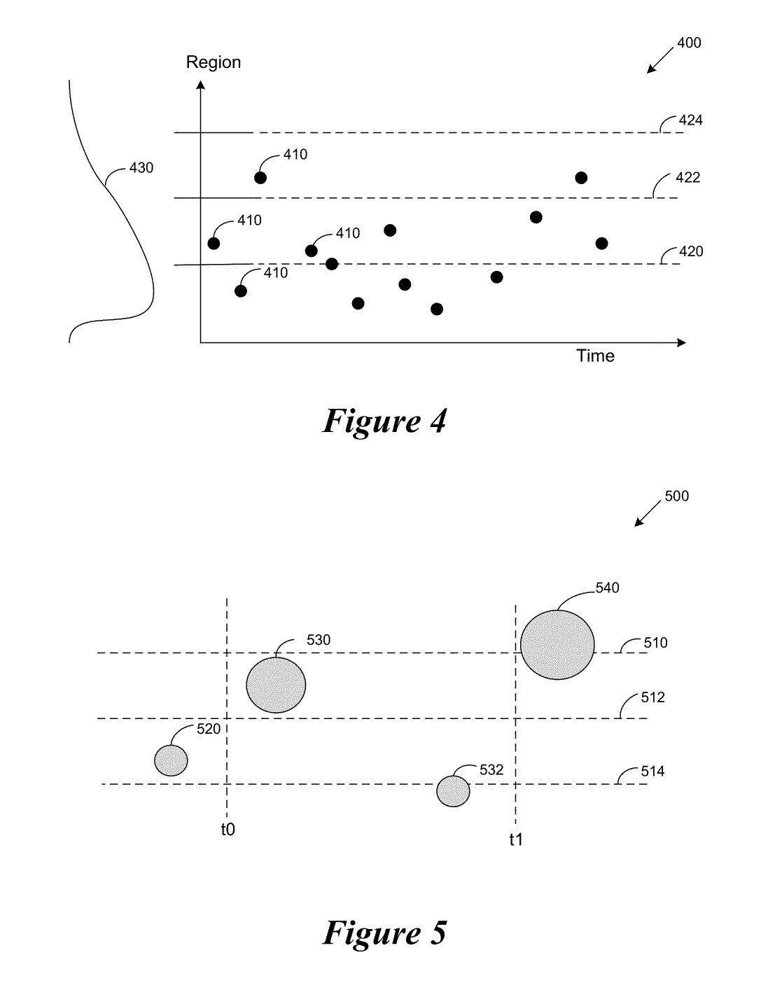

Referring to FIG. 4, a graphical representation 400 of normalized sample points is shown. It will be appreciated that many different algorithms may be used for data analysis and identifying the key parameters that provide an optimal system configuration for a workload by data analytics. The statistical model of the present disclosure uses distribution characteristics of the collected data points and identifies a high confidence mean for the distributed data points. An example of a graphical representation for normalized sample points is shown in FIG. 4.

With the graphical representation 400, the samples 410 are based on the instrumentation and probes that collect representative values to measure application response time (ART), application throughput (AT), and system resource utilization (SRU) for a specific hardware configuration over time t (ART(t), AT(t), and SRU (t)).

Based on user input or heuristics, common workloads for the system and the priorities are determined. A dummy workload representing this workload is executed using the performance optimization system 205 while no other applications are executing.

Hardware binding is established to account for specifics of the hardware platform. More specifically, the hardware binding operation associates a particular hardware platform configuration with the dummy workload load. The dummy workload may then be executed on a plurality of different system configurations to provide baselines for the dummy workload across a plurality of different system configurations.

The performance optimization system 205 establishes a plurality of baseline limits. The graphical representation presents representations of the plurality of baseline limits (e.g., line 420, line 422 and line 424). In certain embodiments, the baseline limits include an optimized baseline limit (as indicated by line 420), a partial optimized baseline limit (as indicated by line 422) and a non-optimized baseline limit (as indicated by line 424). The baseline limits define an optimized region, a partially optimized region and a non-optimized region within the graphical representation. Once the baseline limits are established, proper sampling of the performance probes provide information regarding utilization, responsiveness, and throughput (time to complete the requested job) which are presented within the graphical representation 400. In various embodiments, the performance optimization operation samples at a frequency that allows reconstruction of the signal being sampled (e.g., utilization by a processor over time). In certain embodiments, the performance optimization system samples at a Nyquist frequency. However, a higher sampling rate can lead to slow performance and bad customer experience. Hence, for the purposes of this disclosure proper sampling refers to a maximum sampling rate that is possible without affecting system performance. In this way, rather than a higher sampling rate, the performance optimization operation may sample at a lower rate but for longer durations. If the signal being sampled is persistent, the performance optimization operation will eventually obtain a necessary statistical distribution of the signal.

In various embodiments, the graphical representation 400 also includes a distribution representation 430. The distribution representation 430 provides a graphical representation of the distribution of the samples 410 within the graphical representation 400.

In certain embodiments, the samples are normalized and stored (e.g., within repository 230 and/or repository 240) with a tag to identify the operating region over time. In certain embodiments, the performance optimization system 205 performs Bayesian distribution analytics to determine an appropriate operating region for sufficient number of sample points (e.g., greater than 1000 sample points). A specific sufficient number of sample points varies based upon the probe that is being monitored. For example, with Bayesian statistics, the performance optimization operation might be able to know apriori that 100K data points are enough for characterizing the “# of threads” and so on. In certain embodiments, the performance optimization operation collects data in the thousands of sample points per probe over an hour for performing the analytics operation.

FIG. 5 shows a sample system performance index 500. The sample performance index informs a user of relative performance of the information handling system. The sample performance index 500 provides lines representing the baseline performance index (e.g., line 510, line 512 and line 514). The baseline limits define an optimized region (e.g., via line 510), a partially optimized region (e.g., via line 512) and a non-optimized region (e.g., via line 514) within the graphical representation. Geometric representations (e.g. circles) representing relative performance of the information handling system populate the system performance index 500. Each representation has a size providing a relative representation of how many data points are within the corresponding geometric representation.

More specifically, certain circles (e.g., circle 520) indicate a relative performance of the system before any optimization is applied. At times t0 and t1 where some optimization (e.g., the optimization that was preconfigured by a developer during the developer portion 210) is applied to the information handling system. Other circles (e.g., circle 530, circle 532) represent a performance index for the system after performing a performance optimization operation at time t0 (e.g., the optimization that is performed by the performance optimization operation during the user portion 212). Other circles (e.g., circle 540) represent a performance index for the system after performing a second performance optimization operation at time t1 (e.g., the optimization that is performed by the performance optimization operation during the user portion 212). These circles provide a user friendly means of representing a relative score of the performance index for a particular hardware configuration. In certain embodiments, a user can further select a more detailed view and a more detailed breakdown of utilization, response time, and throughput contributors to the overall score since all the information is stored and tagged.

To determine which parameters should be monitored for a dummy workload, a Multiple Linear Regression (MLR) modeling operation is used in during the developer portion 210) to model a relationship between the variables and their contribution. The MLR modeling operation approximates an impact of variables to the operating mode and desired criteria. Once these variables are identified in during the developer portion 210, they are sampled in during the user portion 212 at runtime, thus eliminating the need to perform a full benchmark testing operation.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for optimizing performance of an information handling system comprising:
identifying a simulated application load that represents a target application workload to use when executing a performance optimization operation based upon a particular workload;
testing the information handling system being optimized by executing the simulated application load that represents the target application workload on the information handling system;
profiling a workload of the information handling system based upon executing the simulated application load that represents the target application workload;
applying performance optimization changes to the information handling system based upon the data analysis, the performance optimization changes being applied automatically and seamlessly;
analyzing performance of the information handling system after the performance analysis changes are applied; and,
presenting information regarding performance improvement to allow a user to appreciate an effect of the performance optimization changes to the information handling system.

2. The method of claim 1, wherein:
a plurality of performance measurements are generated when comparing performance statistics against pre-configured simulated workloads.

3. The method of claim 2, wherein:
the plurality of performance measurements include one or more of response time performance measurements, time to completion performance measurements and latency performance measurements.

4. The method of claim 1, wherein:
the application specific system configuration operation correlates longer benchmark tests to smaller simulated loads to generate an application specific system configuration performance score.

5. The method of claim 1, further comprising:
calculating a performance gain percentage measure after one or more recommended configuration settings are changed.

6. The method of claim 1, wherein:
a plurality of data points are collected when profiling the workload of the information handling system; and,
when analyzing the performance of the information handling system after the performance analysis changes are applied, weighted distribution average of the plurality of data points determines a performance score for a specific hardware configuration.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
identifying a simulated application load that represents a target application workload to use when executing a performance optimization operation based upon a particular workload;
testing the information handling system being optimized by executing the simulated application load that represents the target application workload on the information handling system;
profiling a workload of the information handling system based upon executing the simulated application load that represents the target application workload;
applying performance optimization changes to the information handling system based upon the data analysis, the performance optimization changes being applied automatically and seamlessly;
analyzing performance of the information handling system after the performance analysis changes are applied; and,
presenting information regarding performance improvement to allow a user to appreciate an effect of the performance optimization changes to the information handling system.

8. The system of claim 7, wherein:
a plurality of performance measurements are generated when comparing performance statistics against pre-configured simulated workloads.

9. The system of claim 8, wherein:
the plurality of performance measurements include one or more of response time performance measurements, time to completion performance measurements and latency performance measurements.

10. The system of claim 7, wherein:
the application specific system configuration operation correlates longer benchmark tests to smaller simulated loads to generate an application specific system configuration performance score.

11. The system of claim 7, wherein the instructions executable by the processor are further configured for:
calculating a performance gain percentage measure after one or more recommended configuration settings are changed.

12. The system of claim 7, wherein:
a plurality of data points are collected when profiling the workload of the information handling system; and,
when analyzing the performance of the information handling system after the performance analysis changes are applied, weighted distribution average of the plurality of data points determines a performance score for a specific hardware configuration.

13. A non-transitory, computer-readable storage medium embodying computer program code, the computer program code comprising computer executable instructions configured for:
identifying a simulated application load that represents a target application workload to use when executing a performance optimization operation based upon a particular workload;
testing the information handling system being optimized by executing the simulated application load that represents the target application workload on the information handling system;
profiling a workload of the information handling system based upon executing the simulated application load that represents the target application workload;
applying performance optimization changes to the information handling system based upon the data analysis, the performance optimization changes being applied automatically and seamlessly;
analyzing performance of the information handling system after the performance analysis changes are applied; and,
presenting information regarding performance improvement to allow a user to appreciate an effect of the performance optimization changes to the information handling system.

14. The non-transitory, computer-readable storage medium of claim 13, wherein:
a plurality of performance measurements are generated when comparing performance statistics against pre-configured simulated workloads.

15. The non-transitory, computer-readable storage medium of claim 14, wherein:
the plurality of performance measurements include one or more of response time performance measurements, time to completion performance measurements and latency performance measurements.

16. The non-transitory, computer-readable storage medium of claim 13, wherein:
the application specific system configuration operation correlates longer benchmark tests to smaller simulated loads to generate an application specific system configuration performance score.

17. The non-transitory, computer-readable storage medium of claim 13, wherein the computer executable instructions are further configured for:
calculating a performance gain percentage measure after one or more recommended configuration settings are changed.

18. The non-transitory, computer-readable storage medium of claim 13, wherein:
a plurality of data points are collected when profiling the workload of the information handling system; and,
when analyzing the performance of the information handling system after the performance analysis changes are applied, weighted distribution average of the plurality of data points determines a performance score for a specific hardware configuration.
